(19) United States
(12) Patent Application Publication
(10) Pub. No.: US 2025/0129563 A1
(43) Pub. Date: Apr. 24, 2025

(54) HYBRID PREFABRICATED FOUNDATION FOR TOWERS AND METHOD OF INSTALLING A HYBRID PREFABRICATED FOUNDATION FOR TOWERS

(71) Applicant: ACCIONA GENERACIÓN RENOVABLE, S.A., Sarriguren (NAVARRA) (ES)

(72) Inventor: Massimiliano PIRLETTI, Sarriguren (ES)

(21) Appl. No.: 18/689,694

(22) PCT Filed: Sep. 6, 2021
(86) PCT No.: PCT/ES2021/070648

§ 371 Date: Mar. 6, 2024

(51) Int. Cl. E02D 27/42

(52) U.S. Cl. CPC E02D 27/425

(57) ABSTRACT

A hybrid prefabricated foundation for towers, comprising a slab (3) made in-situ, and also a pedestal (4) for attaching a tower (12) and ribs (8), consisting of upper pieces (1) prefabricated with a rib (8) and an upper sector (4′), and lower pieces (2) prefabricated with a rib (8) and a lower sector (4″), the upper and lower pieces being disposed in a radially alternating manner and overlapping with one another vertically, such that the upper sectors (4′) of the upper pieces (1) are arranged on the lower sectors (4″) of the adjacent lower pieces (2). Anchor holes (6) extend through the pedestal (4) for anchor bolts (14) for anchoring the tower (12) to the pedestal (4), and post-tensioning bolts (10) are housed in through-housings (5) in the pedestal (4). The invention also relates to a method of installing the hybrid prefabricated foundation for towers.

### FIELD OF THE INVENTION

The present invention belongs to the construction sector, specifically to the construction of towers, masts and poles, and more specifically to the installation of wind turbines towers, and specifically to the foundation of such towers. The present invention relates to a hybrid prefabricated tower foundation, i.e., having prefabricated parts such as pedestal and ribs, and additionally the bottom slab which is in situ concrete. The present invention further relates to a method of installing said hybrid prefabricated tower foundation.

### BACKGROUND OF THE INVENTION

In the wind sector, different typologies of foundations are currently used to support wind turbine towers. First of all, complete foundations can be made in situ, i.e, all the concreting and manufacture of these is carried out in the place where they will be installed. Although this modality has some advantages such as the savings in transport costs of the pieces and in their storage, it also has drawbacks as the extension of the deadlines of completion time and therefore of the total costs of the work, as well as the increase in construction costs due to the lack of serial production.

Alternatively, there is a foundation solution directed to the support and foundation of steel towers, which belongs to the segment of foundations called hybrids, since they are formed in part by prefabricated concrete elements and in part by in situ concrete elements. In this typology of foundation, the ribs and pedestal are usually prefabricated, while the bottom slab is executed in situ concrete.

In relation to this typology, in the currently existing solution, the ribs are prefabricated, each of them with a pedestal sector to which they are attached, and on site all the pedestal sectors are arranged radially with the included ribs, and a lateral joint is made, i.e, the lateral faces of the pedestal sectors are joined with the lateral faces of the adjoining pedestal sectors forming the complete pedestal. Subsequently the bottom slab is concreted. FIGS. 1 and 2 schematically show this type of hybrid prefabricated foundation.

The detail of this currently used technical solution is described in document ITM120091559A1. This embodiment employs post-tensioned cables that circumferentially bind all the pedestal sectors that form the complete pedestal, as shown schematically in FIG. 3. In this case, the joint between all the pedestal sectors is achieved by means of the compression of the cables, which is transmitted thanks to the contact between the lateral faces of the pedestal sectors.

This type of embodiment that is based on the contact between the lateral faces of the pedestal sectors presents the problem that it requires a perfect geometry of the pieces, and joint between them without margin of error. If only one piece of pedestal sector showed a minimum geometric deviation of the side faces, then the correct mounting of the foundation could no longer be achieved.

Another drawback related to this solution is the insertion inside the prefabricated pieces of the pedestal sectors of the sheaths for the passage of the circumferential post-tensioning cables. Generally, in the interior of the pieces, the density of reinforcement is so high that the operation of making holes and installing such sheaths is quite complicated.

A hybrid prefabricated foundation for towers and a method of installing thereof which allows a simple and efficient installation avoiding the existing drawbacks in the state-of-the-art systems are therefore desirable.

### DESCRIPTION OF THE INVENTION

The present invention solves the problems existing in the state of the art by means of a hybrid prefabricated foundation for towers, which is formed by a circular slab made in-situ, being arranged thereon a set formed by a cylindrical pedestal and by a plurality of ribs joined by an end joining to said pedestal, and arranged radially on the slab. A tower will be attached to the pedestal by means of the tower's bolt cage, which has a plurality of anchor bolts, a lower flange and an upper flange. The foundation is considered a hybrid prefabricated because it has prefabricated elements in the workshop (ribs and pedestal) and others made in the in-situ work (bottom slab).

It should be noted that the bolt cage that includes the anchor bolts, the lower flange and the upper flange, is not part of the foundation, subject matter of this invention, but is an integral part of the tower. The foundation, subject matter of this invention, will be adapted to the bolt cage of the tower to be supported, and not vice versa.

In the present invention the pedestal and rib set is constituted by a plurality of prefabricated upper pieces and a plurality of prefabricated bottom pieces. The upper pieces in turn have a rib, and attached to the upper part of their joining end an upper pedestal sector in such a way that a portion of the upper pedestal sector remains on each side of the rib, while the lower pieces have in turn, a rib, and attached to the lower part of its joining end a lower pedestal sector in such a way that a portion of the lower pedestal sector remains on each side of the rib. In this way, the upper pieces and the lower pieces are placed radially alternated with each other and are joined together vertically overlapped alternately, i.e, an upper piece, a lower piece, an upper piece, etc. This vertical overlap is carried out in such a way that each upper pedestal sector portion of each upper piece is arranged on a lower pedestal sector portion of each of the lower pieces adjacent to each upper piece. Thus, in each of the upper pieces, one of the upper pedestal sector portions on one side of the rib is disposed on a lower pedestal sector portion of the lower piece adjacent to one side of the upper piece, while the other upper pedestal sector portion on the other side of the rib is disposed on a lower pedestal sector portion of the lower piece adjacent to the other side of the upper piece. By means of this configuration the upper pedestal sectors of the upper pieces are arranged on the lower pedestal sectors of the contiguous lower pieces, forming the upper pedestal sectors and the lower pedestal sectors the complete pedestal, fitting the upper pieces on the lower pieces as in a puzzle, obtaining the complete pedestal.

This pedestal has a plurality of anchor holes parallel to the axis of the pedestal and passing through the entire height of said pedestal, to house anchor bolts of the tower, for anchoring said tower to the pedestal. Logically, these pass-through anchor holes along the pedestal are obtained by a set of pass-through holes arranged in the upper pedestal sectors and a set of pass-through holes arranged in the lower pedestal sectors, the holes of the upper pedestal sectors being aligned with the holes of the lower pedestal sectors, to form the pass-through anchor holes of the complete pedestal.

Additionally, the foundation has a plurality of post-tensioning bolts that are housed in a plurality of pass-through housings arranged on the pedestal, parallel to the axis of said pedestal. As in the case of anchor holes, these pass-through housings along the pedestal are obtained by a set of pass-through housings arranged in the upper pedestal sectors and a set of pass-through housings arranged in the lower pedestal sectors, the housings of the upper pedestal sectors being aligned with the housings of the lower pedestal sectors, to form the pass-through housings of the complete pedestal.

According to a particular embodiment of the invention, the lower base of the upper pedestal sectors presents crenellations while the upper base of the lower pedestal sectors presents crenellations complementary to the crenellations of the upper pedestal sectors, in such a way that said crenellations of both pedestal sectors fit together ensuring and improving the joint between the upper pieces and the lower pieces. This option complicates the manufacture of the molds of the upper and lower pieces, so it will be applied only in the case that the anchor pins, and the post-tensioning pins where appropriate are insufficient for the fixing of the upper pedestal sectors on the lower pedestal sectors.

The main difference between the foundation, subject matter of the present invention, and the state-of-the-art existing prefabricated hybrid consists in the form of joining the prefabricated parts together to form the pedestal. In the case of the state-of-the-art foundations, the different sectors are joined laterally, i.e, the lateral faces of the pedestal sectors are joined to the lateral faces of the adjoining pedestal sectors and a post-tensioning and a circumferential joint are carried out. However, in the case of the foundation of the present invention, to form the complete pedestal, the different sectors or portions overlap vertically, i.e., the upper pedestal sectors are joined over the lower pedestal sectors.

The upper pieces and the lower pieces are joined together by overlapping vertically, one over the other, in the pedestal area. The tightening between these pieces is carried out by using the bolt cage (including the anchor bolts and upper and lower flanges), crossing the anchor bolts the upper and lower pieces, and preferably by using post-tensioned bolts that also cross the upper and lower pieces.

In addition, the friction between the lower face of the upper pedestal sector and the upper face of the lower pedestal sector prevents lateral displacements, providing greater security to the joint.

With this type of joint, it is no longer necessary to have contact between the lateral faces of the pedestal sectors, thus being able to leave a tolerance between pieces and obviate the inconvenience presented by the foundation of the state of the art. In addition, since it is not necessary to use circumferential post-tensioning cables, it is not necessary to install them inside the pedestal sectors, nor the creation of sheaths for their passage inside these sectors.

Additionally, the present invention relates to a method of installing the hybrid prefabricated foundation for towers described above, which presents the following steps:
First, a pouring of cleaning concrete is carried out in the area in which the foundation will be carried out, then the positioning on said cleaning concrete of the anchor bolts and the lower flange of the tower to be installed on the foundation, and then the positioning of the lower pieces (which include the ribs and the lower pedestal sectors, leaving a portion of the lower pedestal sector on each side of the rib) on the cleaning concrete, introducing the anchor bolts through the anchor holes of the lower pedestal sectors.
Subsequently, the lower pieces are leveled to fix them in their exact position.
Next, the upper pieces (which include the ribs and the upper pedestal sectors, leaving an upper pedestal sector portion on each side of the rib) are positioned on the lower pieces, so that the upper pieces and the lower pieces are placed radially alternated with each other and are joined together vertically overlapped alternately, i.e, an upper piece, a lower piece, an upper piece, etc. This vertical overlap is carried out in such a way that each upper pedestal sector portion of each upper piece is arranged on a lower pedestal sector portion of each of the lower pieces adjacent to each upper piece. Thus, in each of the upper pieces, one of the upper pedestal sector portions on one side of the rib is disposed on a lower pedestal sector portion of the lower piece adjacent to one side of the upper piece, while the other upper pedestal sector portion on the other side of the rib is disposed on a lower pedestal sector portion of the lower piece adjacent to the other side of the upper piece. By means of this configuration the upper pedestal sectors of the upper pieces are arranged on the lower pedestal sectors of the contiguous lower pieces, forming the upper pedestal sectors and the lower pedestal sectors the complete pedestal, fitting the upper pieces on the lower pieces as in a puzzle, obtaining the complete pedestal. At this step the anchor bolts are introduced through the anchor holes of the upper pedestal sectors.
Then the upper pieces are leveled, in order to guarantee full contact between the faces of the upper and lower pieces, and the post-tensioning bolts are installed in the pedestal housings and the tightening of these post-tensioning bolts is carried out.
Then the concreting of the slab is carried out and the positioning of the upper flange of the tower bolt cage on top of the anchor bolts that protrude from the pedestal.
Finally, the mounting of the tower and subsequent post-tensioning of the anchor pins is carried out to leave the pedestal fully realized and fixed.

According to a preferred embodiment of the method of installation of the foundation, after the positioning of the upper pieces on the lower pieces a post-tensioning of the pedestal is carried out by introducing post-tensioning bolts into the pedestal housings, and finally, after the mounting of the tower and the post-tensioning of the anchor bolts a new tensioning, or additional re-tensioning of these post-tensioning bolts is carried out.

### BRIEF DESCRIPTION OF THE FIGURES

In order to facilitate understanding of the invention, an embodiment of the invention referring to a number of figures will now be described by way of illustration, but not limitation.

FIG. 1 shows an initial step of a foundation of the state of the art in which all the pieces formed by a rib and a pedestal sector joined laterally forming the complete pedestal are observed.

FIG. 2 shows a final step of the foundation of the state of the art of FIG. 1 in which the bottom slab has been concreted.

FIG. 3 shows a horizontal section view of the foundation of the state of the art of FIGS. 1 and 2, which shows post-tensioned cables that circumferentially bind all the pedestal sectors that form the complete pedestal.

FIG. 4 is a perspective of an embodiment of the foundation subject matter of the present invention showing its main components, with the tower attached to said foundation FIG. 5 is a prefabricated upper part of the foundation of FIG. 4, showing a portion of the upper pedestal sector on each side of the rib.

FIG. 6 is a prefabricated bottom piece of the foundation of FIG. 4, showing a lower pedestal sector portion on each side of the rib.

FIG. 7 is a detailed view of an embodiment of the foundation in which the tower is not arranged to be able to show the anchor bolts of said tower, and in which one of the upper pieces and a post-tensioning bolt are not completely installed to show the mounting in detail.

FIG. 8 shows in detail the pedestal between two ribs, showing an upper pedestal sector arranged on a lower pedestal sector.

FIG. 9 shows in detail a particular embodiment of a lower part which comprises crenellated on its upper surface.

FIGS. 10a-10e show in sequence the different steps of a method of installing the hybrid prefabricated foundation for towers, subject matter of the present invention.

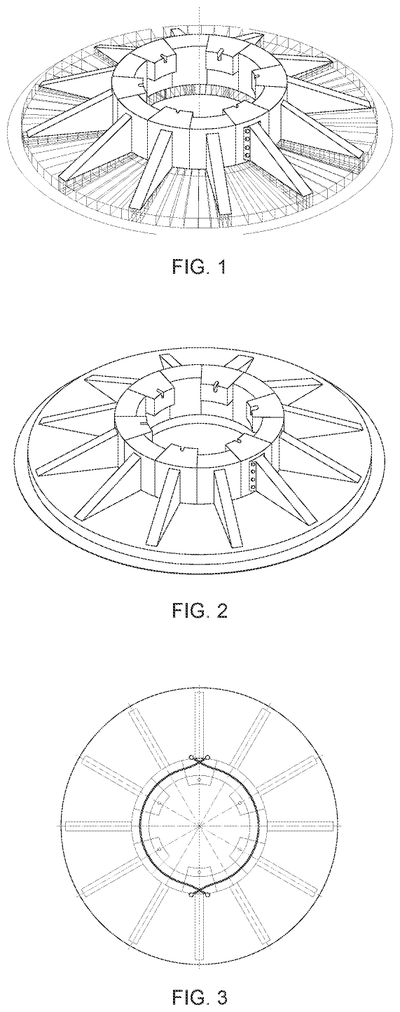

In these figures, reference is made to a set of elements that are:
1. upper pieces
2. lower pieces
3 slab
4. pedestal
4′. upper pedestal sectors
4″. lower pedestal sectors
5. post-tensioning bolt housings
6. Anchor holes
7. reinforcement at the bottom of the ribs
8. ribs
9. support legs at the bottom of the ribs
10. post-tensioning bolts
11. end of joining nerves to pedestal
12. tower
13. upper flange of tower anchor bolts
14. Tower anchor bolts
15. lower flange of tower anchor bolts
16. cleaning concrete
17. crenellations

### DETAILED DESCRIPTION OF THE INVENTION

The subject matter of the present invention is a hybrid prefabricated foundation for towers (12).

As can be seen in the figures, the foundation is formed by a circular slab (3) made in-situ, being arranged in said slab (3) a set formed by a cylindrical pedestal (4) and by a plurality of ribs (8) joined by an joining end (11) to said pedestal (4), being said ribs (8) arranged radially on the slab (3). A tower (12) will be attached to the pedestal (4), concentric with the slab (3), by means of the tower's bolt cage, which has a plurality of anchor bolts (14), a lower flange (15) and an upper flange (13). Each of the ribs (8) has at its bottom at least one support leg (9) for fixing the floor ribs (specifically to the cleaning concrete (16)). In addition, the ribs (8) also have in their lower part an reinforcement armature (7) for fixing the ribs in the concreting of the slab (3).

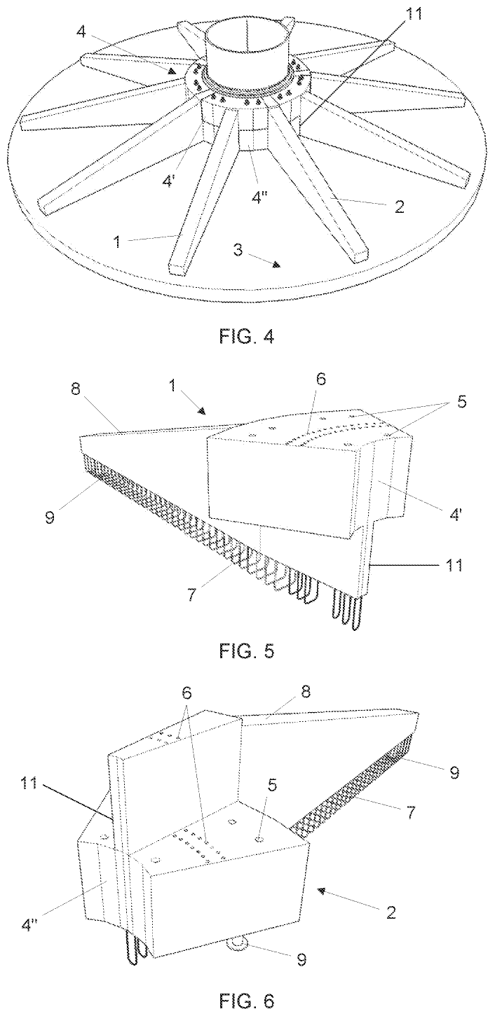

As can be seen in the figures, especially in FIGS. 4, 5 and 6, the pedestal (4) and rib (8) set is constituted by a plurality of prefabricated upper pieces (1) and a plurality of prefabricated bottom pieces (2). The upper pieces (1) in turn have a rib (8), and attached to the upper part of its joining end (11) an upper pedestal sector (4′) in such a way that a portion of the upper pedestal sector (4′) remains on each side of the rib (8), while the lower pieces (2) have in turn a rib (8), and attached to the lower part of its joining end (11) a lower pedestal sector (4″) in such a way that a portion of the lower pedestal sector (4″) remains on each side of the rib (8). FIGS. 5 and 6 show an upper piece (1) and a lower piece (2) respectively. In this way, the upper pieces (1) and the lower pieces (2) are placed radially alternated with each other and are joined together vertically overlapped alternately, i.e, an upper piece (1), a lower piece (2), an upper piece (1), etc. This vertical overlap is carried out in such a way that each upper pedestal sector portion (4′) of each upper piece (1) is arranged on a lower pedestal sector portion (4″) of each of the lower pieces (2) adjacent to each upper piece (1). Thus, in each of the upper pieces (1), one of the upper pedestal sector portions (4′) on one side of the rib (8) is disposed on a lower pedestal sector portion (4″) of the lower piece (2) adjacent to one side of the upper piece (1), while the other upper pedestal sector portion (4′) on the other side of the rib (8) is disposed on a lower pedestal sector portion (4″) of the lower piece (2) adjacent to the other side of the upper piece (1). By means of this configuration the upper pedestal sectors (4′) of the upper pieces (1) are arranged on the lower pedestal sectors (4″) of the lower pieces (2), forming all the upper pedestal sectors (4′) and all the lower pedestal sectors (4″) of the complete pedestal (4). FIG. 4 shows the pedestal (4) and rib (8) set formed by the upper pieces (1) and the bottom pieces (2).

Preferably, foundations of ten ribs (8) are usually made, so that said foundations will be formed by five upper pieces (1) and five lower pieces (2), although the number of ribs (8) can vary, being logically always the foundation formed by the same number of upper pieces (1) that of lower pieces (2).

This pedestal (4) has a plurality of anchor holes (6) that are parallel to the axis of the pedestal (4) and passing through the entire height of the pedestal (4), to house anchor bolts (14) of the tower (12), intended for anchoring said tower (12) to the pedestal (4). Logically, these anchor holes (6) through along the pedestal (4) are obtained by a set of pass-through holes arranged in the upper pedestal sectors (4′) and a set of pass-through holes arranged in the lower pedestal sectors (4″), the holes of the upper pedestal sectors (4′) being aligned with the holes of the lower pedestal sectors (4″), to form the anchor holes (6) passing through the complete pedestal (4).

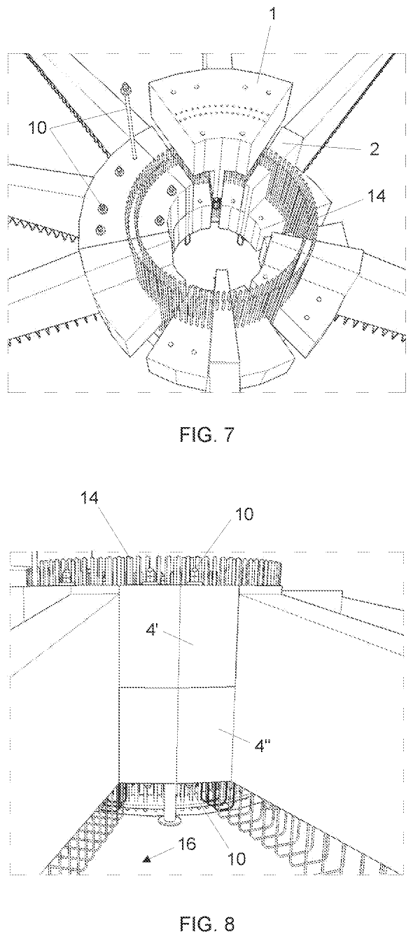

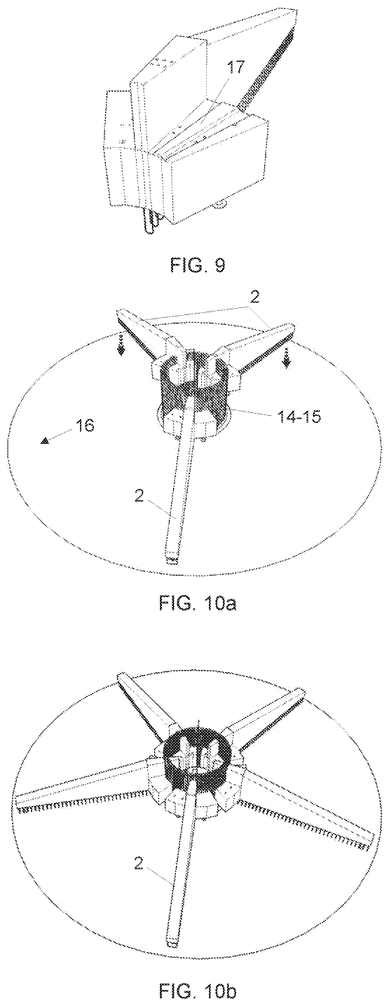

Additionally, as can be seen in FIGS. 4 and 7, the foundation has a plurality of post-tensioning bolts (10), which are housed in a plurality of pass-through housings (5) arranged on the pedestal (4), parallel to the axis of said pedestal (4). As in the case of the anchor holes (6), these housings (5) through along the entire height of the pedestal (4) are obtained by a set of pass-through housings arranged in the upper pedestal sectors (4′) and a set of pass-through housings arranged in the lower pedestal sectors (4″), the housings of the upper pedestal sectors (4′) being aligned with the housings of the lower pedestal sectors (4″), to form the pass-through housings (5) of the complete pedestal (4).

Access to the post-tensioning bolts (10) is guaranteed by both ends, thanks to a free distance existing between the lower piece (2) and the cleaning concrete (16), as can be seen in FIG. 8.

According to a particular embodiment of the invention, the lower base of the upper pedestal sectors (4′) presents crenellations (17), while the upper base of the lower pedestal sectors (4″) presents crenellations (17) complementary to the crenellations (17) of the upper pedestal sectors (4′), in such a way that said crenellations (17) of both pedestal sectors (4′, 4″) fit together ensuring and improving the joint between the upper pieces (1) and the lower pieces (2) of the foundation.

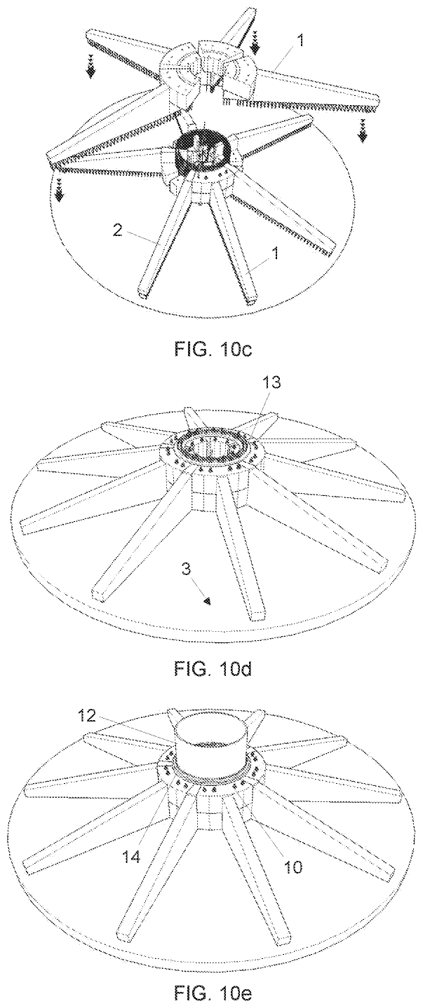

Additionally, the present invention relates to a method of installing the hybrid prefabricated foundation for towers (12) described above, which presents the following steps:
FIG. 10a shows a first step in which a pouring of cleaning concrete (16) is carried out in the area in which the foundation will be carried out, then the positioning on said cleaning concrete (16) of the anchor bolts (14) and the lower flange (15) of the tower (12) to be installed on the foundation is carried out, and then the positioning of the lower pieces (2) (which include the ribs (8) and the lower pedestal sectors (4″) is carried out, leaving a portion of the lower pedestal sector (4″) on each side of the rib (8)) on the cleaning concrete (16), introducing the anchor bolts (14) through the holes of the lower pedestal sectors (4″).
FIG. 10b shows a second step in which the lower pieces (2) are leveled to fix them in their exact position.
FIG. 10c shows a third step in which the upper pieces (1) (which include the ribs (8) and the upper pedestal sectors (4′) are positioned, leaving an upper pedestal sector portion (4′) on each side of the rib (8)) on the lower pieces (2), so that the upper pieces (1) and the lower pieces (2) are placed radially alternated with each other and are joined together vertically overlapped alternately, i.e, an upper piece (1), a lower piece (2), an upper piece (1), etc. This vertical overlap is carried out in such a way that each upper pedestal sector portion (4′) of each upper piece (1) is arranged on a lower pedestal sector portion (4″) of each of the lower pieces (2) adjacent to each upper piece (1). Thus, in each of the upper pieces (1), one of the upper pedestal sector portions (4′) on one side of the rib (8) is disposed on a lower pedestal sector portion (4″) of the lower piece (2) adjacent to one side of the upper piece (1), while the other upper pedestal sector portion (4′) on the other side of the rib (8) is disposed on a lower pedestal sector portion (4″) of the lower piece (2) adjacent to the other side of the upper piece (1). By means of this configuration the upper pedestal sectors (4′) of the upper pieces (1) are arranged on the lower pedestal sectors (4″) of the lower pieces (2), forming the upper pedestal sectors (4′) and the lower pedestal sectors (4″) of the complete pedestal (4), fitting the upper pieces (1) on the lower pieces (2) as in a puzzle, obtaining the complete pedestal (4). At this step the anchor bolts (14) are introduced through the holes of the upper pedestal sectors (4′). Leveling of the upper pieces (1) and introduction and tightening of post-tensioning bolts (10) in housings (5) of the pedestal (4) is also carried out.
FIG. 10d shows a fourth step in which the concreting of the slab (3) and the positioning of the upper flange (13) of the tower bolt cage (12) is carried out on the upper part of the anchor bolts (14) that protrude from the pedestal (4) formed by the upper pedestal sectors (4′) arranged on the lower pedestal sectors (4″).
FIG. 10e shows the last step in which the mounting of the tower (12) and subsequent post-tensioning of the anchor pins (14) is carried out to leave the pedestal (4) and the tower (12) fully realized and fixed to it.

According to a preferred embodiment of the method of installation of the foundation, after the mounting of the tower (12) and the post-tensioning of the anchor bolts (14) a new tensioning, or additional re-tensioning of these post-tensioning bolts (10) is carried out to affirm the clamping.

1. A hybrid prefabricated foundation for towers, comprising a circular slab (3) made in-situ, and arranged therein a set formed by a cylindrical pedestal (4) and by a plurality of ribs (8) joined by an joining end (11) to said pedestal (4), and arranged radially on the slab (3), the pedestal (4) being configured for the fixing of a tower (12), characterized in that the set of pedestal (4) and ribs (8) is constituted by
a plurality of upper pieces (1) prefabricated, which in turn comprise a rib (8), and attached to the upper part of its connection end (11) an upper pedestal sector (4′) in such a way that a portion of the upper pedestal sector portion (4′) remains on each side of the rib (8), and
a plurality of prefabricated lower pieces (2), which in turn comprise a rib (8), and attached to the lower part of its connection end (11) a lower pedestal sector (4″) in such a way that a portion of the lower pedestal sector (4″) remains on each side of the rib (8), the upper pieces (1) and the lower pieces (2) being arranged radially alternated with each other, alternately vertically overlapping each other, each portion of the upper pedestal sector (4′) of each upper piece (1) being arranged on a portion of the lower pedestal sector (4″) of each of the lower pieces (2) adjacent to each upper piece (1), in such a way that the upper pedestal sectors (4′) of the upper pieces (1) are arranged on the lower pedestal sectors (4″) of the adjacent lower pieces (2), the upper pedestal sectors (4′) and the lower pedestal sectors (4″) forming the pedestal (4),
the pedestal (4) comprising:
a plurality of anchor holes (6) parallel to the axis of the pedestal (4) and passing through the entire height of said pedestal (4), configured to house anchor bolts (14) of the tower (12), for anchoring said tower (12) to the pedestal (4), and
a plurality of post-tensioning bolts (10) housed in a plurality of housings (5) arranged on the pedestal (4), parallel to the axis of said pedestal (4) and passing through thereof.

2. The hybrid prefabricated foundation for towers according to claim 1, wherein the lower base of the upper pedestal sectors (4′) comprises crenellations (17) and the upper base of the lower pedestal sectors (4″) comprises crenellations (17) complementary to the crenellations (17) of the upper pedestal sectors (4′), said crenellations (17) of both pedestal sectors (4′, 4″) being fitted together.

3. A method of installing the hybrid prefabricated foundation for towers of claim 1, comprising the following steps:
pouring of cleaning concrete (16), positioning on said cleaning concrete (16) of anchor bolts (14) and lower flange (15) of the tower (12), and positioning of the lower pieces (2) on the cleaning concrete (16) by introducing the anchor bolts (14) through the anchor holes (6) of the lower pedestal sectors (4″),
levelling of the lower pieces (2),
positioning of the upper pieces (1) on the lower pieces (2) by introducing the anchor bolts (14) through the anchor holes (6) of the upper pedestal sectors (4′), levelling of the upper pieces (1) and introduction and tightening of post-tensioning bolts (10) in housings (5) of the pedestal (4),
concreting of the slab (3) and positioning of the upper flange (13) on the upper part of the anchor pins (14) that protrude from the pedestal (4),
mounting of the tower (12) and post-tensioning of the anchor pins (14).

4. The method of installing the prefabricated hybrid foundation for towers according to claim 3, wherein after the mounting of the tower (12) and the post-tensioning of the anchor pins (14) a further re-tensioning of the post-tensioning pins (10) is carried out.
